(19) United States
(12) Patent Application Publication
(10) Pub. No.: US 2018/0128402 A1
(43) Pub. Date: May 10, 2018

(54) Resin Line with Circumferential Openings

(71) Applicant: Faserverbund Innovations UG (haftungsbeschränkt), Ibbenbüren (DE)

(72) Inventor: Dominik Dierkes, Ibbenbüren (DE)

(21) Appl. No.: 15/789,278

(22) Filed: Oct. 20, 2017

(30) Foreign Application Priority Data
Nov. 7, 2016 (DE) 10 2016 121 245.8

(51) Int. Cl. F16L 11/15; F16L 11/18

(52) U.S. Cl. CPC F16L 11/15; F16L 11/18

(57) ABSTRACT

In order to provide a resin line that can be produced inexpensively, that meets the static requirements under action of the vacuum, and that enables a more precise discharge of the matrix material independent of the bending radii at which the resin line is laid, the resin line is formed of a corrugated pipe (2) whose wall comprises through openings (4). The through openings vary in regard to shape, size and/or frequency across a length of a corrugated pipe section of the corrugated pipe.

The present invention concerns a resin line with circumferential openings.

A resin line of the aforementioned kind is disclosed in the publication DE 10 2014 011 787 A1. As a resin line, a flexible spiral hose is disclosed in this publication. For producing a fiber composite component, the resin line is inserted into a tool in order to supply under a vacuum a liquid matrix material to reinforcement fibers placed into the tool. The reinforcement fibers can be present as semifinished fiber products as rovings, mats, laid material, woven material, multi-axial materials, knitted materials, and mesh material, and can be produced of very different fiber materials, for example, carbon fibers, glass fibers, aramid fibers, boron fibers or hybrid materials, also in any combination. The reinforcement fibers are impregnated with the matrix material supplied through the resin line. In this context, the matrix material also fills out the tool. As matrix materials, different suitable resin systems can be employed that exhibit a suitable viscosity in the working temperature range and bond well to the reinforcement fibers. After complete impregnation of the reinforcement fibers and filling of the mold chamber, the matrix material cures in the tool. Subsequently, the finished component can be removed from the tool. The vacuum infusion method is described in an exemplary fashion in the publication DE 102 39 325 B4.

The flexible spiral hoses that are known in the prior art are relatively expensive in regard to manufacture. They must have a relatively thick wall in order not to collapse under action of the vacuum. Depending on the bending radii at which the spiral hoses are laid, the spirals open to different degrees so that the discharge of the matrix material is not uniform everywhere across the length of the resin line. In order to adjust their permeability to different specifications, it is necessary to employ different hoses, respectively, wherein for their manufacture different tools are required, respectively. A variable adaptation to different permeability specifications is therefore possible only with differently stocked hose types.

It is the object of the present invention to provide a resin line which can be produced inexpensively, that meets the static requirements under action of the vacuum, and that enables a more precise discharge of the matrix material independent of the bending radii at which the resin line is laid.

The object we solved for a resin line according to the invention in that the resin line is formed of a corrugated pipe whose wall comprises through openings.

The proposed corrugated pipe is a pipe of a stiff material that can be flexibly laid due to the corrugated shape. The corrugated pipe is preferably produced of a thermoplastic synthetic material, for example, a polyamide, polyethylene, polyvinyl chloride, polytetrafluoroethylene or a polypropylene. The employed synthetic material must exhibit a sufficient strength in the working temperature range of the matrix material in order not to collapse under the vacuum in the tool and/or soften or become liquid due to the heat of the matrix material or the solvents contained therein such that the matrix material is no longer reliably distributed in the tool or the matrix material becomes contaminated by the material of the corrugated pipe.

The wall of the corrugated pipe has a diameter that changes undulatingly across its length. Depending on the employed material, the wall thickness of the material in comparison to spiral hoses can be reduced to a thickness of 0.2 to 0.4 mm. The corrugations of the corrugated pipe can be designed to be parallel annular or the corrugations extend in a spiral shape so that the flow behavior of the matrix material can be improved. Due to the undulated shape of the wall, there is a tendency to generate turbulences in the matrix material upon passing through, causing the flow rate to be reduced. At the low flow rates of the matrix material these effects are however negligible. Advantageous is however the homogenous temperature distribution of the matrix material across the cross section of the resin line, in particular when starting the infusion, which is caused by the turbulences.

In comparison to a smooth wall surface, the corrugations of the corrugated pipe provide increased stiffness and carrying capacity in radial direction of the corrugated pipe. In longitudinal direction, the corrugated pipe due to the corrugated shape of the wall can also be easily deformed in bending radii that the corrugated pipe must assume so that it can be placed into a given tool. Accordingly, a corrugated pipe is an ideal material in order to be able to fulfill the stiffness specifications under action of the vacuum but also the flexibility specifications in regard to easy placement of a resin line in a tool.

The corrugated pipe material can be rolled up as an extruded continuous material on drums and easily stored and transported. The corrugated pipe material required for a manufacturing process can be cut to length from the continuous strand at any length. Cutting waste is thus reduced to a minimum.

The corrugated pipe comprises through openings through which the matrix material can pass from the interior of the corrugated pipe to the exterior. The through openings are dimensioned and shaped such that, depending on viscosity and flow behavior of the employed matrix material and the desired course of the flow fronts within the tool during the impregnation phase, the precisely matched quantity of the matrix material exits at a respective desired location. The through openings can be formed in the corrugation bottom or at the corrugation top or can extend across the length of one or several corrugations.

According to an embodiment of the invention, the resin line is jacketed with a flow aid and/or with a nonwoven material. A flow aid is comprised of a net-like fabric that enables the matrix material to flow even under the vacuum pressure of a film positioned on top. The flow aid is also advantageous in order to distribute the matrix material exiting from the corrugated pipe as uniformly as possible. Since the tool during the infusion method may be covered by a matrix material-impermeable or gas-impermeable film, it is possible that without a layer of a flow aid the through opening is closed off by the film, in particular when vacuum is applied, so that then no matrix material can exit through this through opening. The flow aid prevents that the through opening can be closed off by a film. The nonwoven serves in particular the purpose of retaining gas bubbles which are contained in the matrix material. When the matrix material begins to infiltrate the nonwoven, the gas bubbles from the first foam will burst and the gas can be removed by suction. When the resin line is filled with liquid matrix material, the gas bubbles adhere due to their surface tension to the nonwoven fibers and do not pass through the nonwoven. The nonwoven retains in this manner the gas bubbles in the matrix material. A reduced number of gas bubbles in the finished fiber composite component improves its quality. For the invention it is of no consequence whether the flow aid or the nonwoven is positioned externally when the corrugated pipe is jacketed with both means.

According to an embodiment of the invention, the shape, size and/or frequency of the through openings across the length of a corrugated pipe section varies. The through openings must not be embodied uniformly across the length of the corrugated pipe; it is also possible to vary the shape, size and/or frequency of the through openings across the length of a corrugated pipe section in order to affect thereby in a targeted fashion the flow behavior of the matrix material in a tool. For this purpose, by means of a machine through openings in different shape, size and/or frequency can be stamped, lasered, melted, cut into the wall of the corrugated pipe or introduced in other ways into the wall. In this way, it is possible to allow in sections more matrix material to flow within a time interval in one tool section than in another tool section, which, for example, in case of fiber composite components with differently embodied material thickness can be advantageous in order to enable uniform advancing of a flow front in the tool.

According to an embodiment of the invention, the resin line is assembled of several corrugated pipe sections which are connected by a coupling member to each other. It is in particular possible to adjoin corrugated pipe sections having a different shape, size and/or frequency of through openings by means of coupling members in order to obtain in this way a corrugated pipe strand that, across its length, allows more or less resin material to exit at certain sections. For this purpose, a manufacturer would have to stock corrugated pipes with different through openings in order to connect them selectively in sections with each other to a resin line. Alternatively, it is possible that a manufacturer stocks a perforation machine with which he provides a corrugated pipe type, depending on the actual need, with through openings with a different shape, size and/or frequency. A manufacturer can thus produce corrugated pipe sections as he currently needs them.

According to an embodiment of the invention, the corrugated pipe sections with a different diameter are connected to each other by means of coupling members to a resin line. By means of different diameters, different pressure conditions in the corresponding sections of the resin line can be adjusted. When a resin line is assembled, for example, of several sections whose diameter decreases the farther the section is removed from the location where the matrix material is introduced into the resin line, the pressure drop that is produced for a uniform diameter of the resin line across its length can be at least partially compensated in this way, for example. It is also possible to divide a thicker resin line in the area of a coupling into two thinner resin line strands so that the matrix material can be supplied to the tool across a larger surface area without pressure loss in the resin line. By means of influencing the pressure in the resin line, also the speed can be affected at which the matrix liquid exits from this section of a resin line. The use of corrugated pipe sections with a different diameter can thus also contribute to the matrix material being distributed in a tool more uniformly and in a more targeted fashion with a flow front affected in a targeted fashion.

It is expressly noted that the afore described configurations of the inventions by themselves but also in any combination with each other can be combined with the subject matter of claim 1.

Further advantageous modifications and embodiments of the invention can be taken from the following subject matter description and the drawings.

The invention will be explained in more detail with the aid of an embodiment. It is shown in:

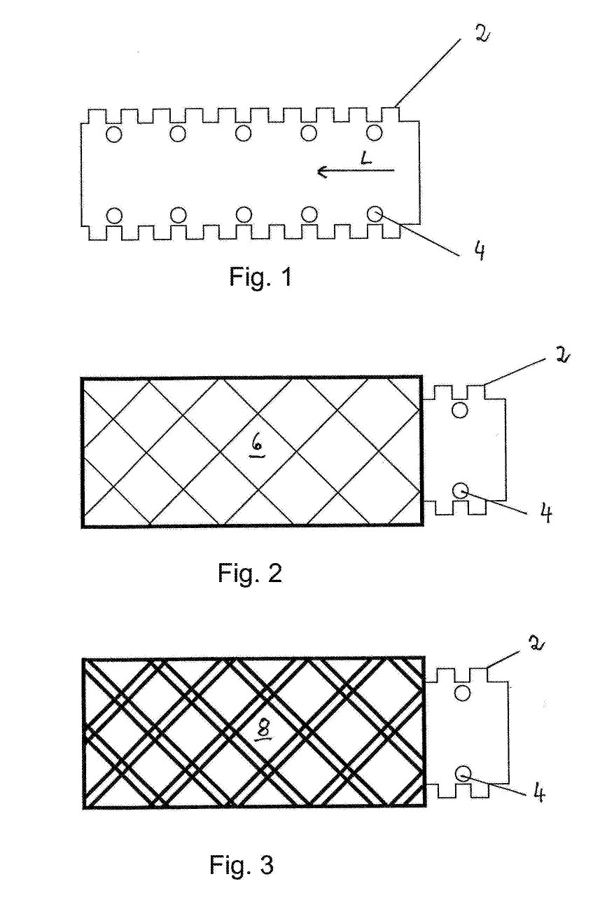

FIG. 1: a view of a corrugated pipe;

FIG. 2: a view of a corrugated pipe with a flow aid; and

FIG. 3: a view of a corrugated pipe with an additional nonwoven.

FIG. 1 shows schematically the contour of a corrugated pipe 2. Also schematically indicated are through openings 4 which are provided in the wall of the corrugated pipe 2. In the illustrated embodiment, the corrugated pipe 2 is comprised of a sequence of parallel annular shaped parts. In the embodiment, the rings are shown with an angled cross section contour; however, the rings can also have a rounded cross section contour, for example, semi-circularly shaped or with a semi-oval shape.

When a matrix material flows in longitudinal direction L through the corrugated pipe 2, the matrix material can penetrate through the through openings 4 to the exterior. When the corrugated pipe 2 is inserted into a tool for producing a fiber composite component, the matrix material, after exiting the corrugated pipe through the through openings 4, can penetrate into the reinforcement fibers arranged in the tool and can fill out the tool mold.

In FIG. 2, a view of a corrugated pipe is shown that at least partially is jacketed by a flow aid 6. When the matrix material exits from the interior of the corrugated pipe 2 through the through openings 4 to the exterior, the matrix material infiltrates the fiber layer of the flow aid 6, is distributed therein, and can penetrate from there, drawn by the vacuum, farther into the tool. Across the surface area of the flow aid 6, the matrix material is distributed better within the tool.

In FIG. 3, a view of a corrugated pipe 2 is illustrated in which the corrugated pipe 2 is jacketed with an additional nonwoven. The nonwoven serves the purpose of dissolving and retaining gas bubbles which are contained in the matrix material that exits through the through openings 4 from the corrugated pipe 2.

The corrugated pipe according to the invention can be laid in particular along the rim of tools where it is of no consequence that the exterior contour of the corrugated pipe remains as an impression in the cured matrix material. Since in such tools the rim pieces of the fiber composite component are frequently cut off and disposed of, the impressions of the corrugated pipe are not visible in the matrix material of the finished fiber composite component. In such an application the advantages of easy handling of the resin line prevail when it is comprised of a corrugated pipe, as well as the beneficial procurement costs of such a resin line. Important it is important also when using the corrugated pipe as a resin line that the supply of the matrix material into the tool can be controlled better locally in that corrugated pipes with correspondingly embodied through openings are employed.

The afore described embodiment serves for explaining the invention. The invention is not limited to the afore described embodiment. A person of skill in the art will have no difficulties in modifying the embodiment in a way that appears suitable to him in order to adapt it to a concrete application situation.

What is claimed is:

1.-5. (canceled)

6. A resin line comprising a corrugated pipe with a wall comprising circumferential through openings.

7. The resin line according to claim 6, further comprising a flow aid jacketing the corrugated pipe.

8. The resin line according to claim 6, further comprising a nonwoven jacketing the corrugated pipe.

9. The resin line according to claim 6, further comprising a nonwoven jacketing the corrugated pipe and a flow aid jacketing the corrugated pipe.

10. The resin line according to claim 9, wherein the flow aid is placed onto the corrugated pipe and the nonwoven is placed around the flow aid.

11. The resin line according to claim 9, wherein the nonwoven is placed onto the corrugated pipe and the flow aid is placed around the nonwoven.

12. The resin line according to claim 6, wherein the through openings vary in regard to a shape, a size and/or a frequency across a length of a corrugated pipe section of the corrugated pipe.

13. The resin line according to claim 6, wherein the corrugated pipe comprises a plurality of corrugated pipe sections and the corrugated pipe sections are connected to each other by a coupling member, respectively.

14. The resin line according to claim 13, wherein the corrugated pipe sections have different diameters.
